(19) United States
(12) Patent Application Publication
(10) Pub. No.: US 2006/0221205 A1
(43) Pub. Date: Oct. 5, 2006

(54) Digital camera and white balance adjustment method

(76) Inventors: Kenichi Nakajima, Kanagawa (JP); Junzou Sakurai, Tokyo (JP)

Correspondence Address: Pamela R. Crocker, Patent Legal Staff;Eastman Kodak Company, 343 State Street, Rochester, NY, 14650-2201, US

(21) Appl. No.: 11/257,562

(22) Filed: Oct. 25, 2005

(30) Foreign Application Priority Data
Mar. 31, 2005 (JP) 2005-101569

(51) Int. Cl. H04N 9/73

(52) U.S. Cl. 348/226.1

(57) ABSTRACT

A digital camera capable of performing more stable white balance adjustment is provided. In a digital camera for adjusting white balance of a video signal corresponding to an object and supplied from an image sensor, a white balance adjustment circuit 34 changes at least some of a plurality of light source regions predefined on a color difference plane based on a result of detection of flicker in a light source illuminating the object performed by a flicker detection circuit 70. The white balance adjustment circuit 34 then checks which of the plurality of light source regions containing the changed region includes the color difference component of the video signal, thereby estimating the light source of the object, and adjusting white balance in accordance with the estimation result.

### FIELD OF THE INVENTION

The present invention relates to a digital camera and a white balance adjustment method for adjusting white balance of a video signal output from an image sensor.

### BACKGROUND OF THE INVENTION

In digital cameras, such as video cameras and digital still cameras, white balance is automatically adjusted to reproduce a white object in white. As a conventional automatic white balance adjustment method, a method of adjusting the balance of RGB components (three primary color components of red, green, and blue) of a signal for each pixel so that the average of an entire image becomes achromatic color, is well-known in the art. This method, however, tends to result in incorrect white balance adjustment when chromatic colors occupy a major portion of the image.

Such incorrect white balance adjustment is called color failure. A technique disclosed in Japanese Patent Laid-Open Publication No. Hei 5-292533 is known as an automatic white balance adjustment method reducing such color failure. According to this technique, an image is divided into a plurality of blocks, and an average of RGB values in each block is calculated to extract only blocks having an average that falls within a predetermined range. The RGB components are each adjusted so that the average of RGB values in the extracted group of blocks becomes achromatic.

Another automatic white balance adjustment method for reducing color failure is disclosed in Japanese Patent Laid-Open Publication No. Hei 5-7369. In this method, a range of values the white balance adjustment signal can assume is limited, thereby avoiding excessive white balance adjustment.

Further, automatic white balance adjustment methods disclosed in Japanese Patent Laid-Open Publications No. Hei 8-289314 and No. 2000-92509, respectively, are also known. According to such methods, an image is divided into a plurality of blocks, and for each block, a representative value including luminance and color difference representing the block is calculated based on each color value within the block. A light source illuminating an object is estimated using the calculated representative value, and white balance is adjusted in accordance with the estimation result.

However, an image of a white object located under indoor fluorescent lighting usually becomes greenish, and therefore it is hard to distinguish it from an image of a green object, such as plants, under an outdoor solar light source, leading to occasional false estimation of the light source illuminating a white object. As a result, appropriate white balance adjustment may not be performed.

### SUMMARY OF THE INVENTION

The present invention aims to provide a digital camera capable of performing more stable white balance adjustment.

The digital camera according to the present invention is a digital camera for performing white balance adjustment on a video signal corresponding to an object and output from an image sensor, comprising a light source estimation circuit for estimating a light source illuminating the object by checking, among a plurality of light source regions predefined on a color difference plane, which region includes a color difference component of the video signal, an adjustment circuit for adjusting white balance of the video signal in accordance with the estimated light source, and a flicker detection circuit for detecting flicker of the light source illuminating the object, wherein the light source estimation circuit changes the light source region based on a result of flicker detection performed by the flicker detection circuit.

According to the present invention, the light source estimation circuit changes a light source region used for estimating the light source illuminating the object based on a result of flicker detection by the flicker detection circuit. Assuming that, for example, a fluorescent light region and a daylight region are defined as the light source regions, the light source estimation circuit reduces an area of the daylight region overlapping the fluorescent light region when the result of the flicker detection indicates that flicker is present. On the other hand, when the flicker detection result indicates that no flicker is present, the light source estimation circuit reduces an area of the fluorescent light region overlapping the daylight region. As a result, the light source can be more accurately estimated by the light source estimation circuit, thereby achieving more stable white balance adjustment.

### BRIEF DESCRIPTION OF THE DRAWINGS

FIG. 1 shows functional blocks of a digital camera according to an embodiment of the present invention;

FIG. 2 shows in detail functional blocks of an imaging unit in the digital camera according to the embodiment of the present invention;

FIG. 3 schematically shows a circuit configuration of a CMOS image sensor according to the embodiment of the present invention;

FIG. 4 shows in detail the circuit configuration of the CMOS image sensor according to the embodiment of the present invention;

FIG. 5 shows in detail a circuit configuration of a pixel circuit forming part of the CMOS image sensor according to the embodiment of the present invention;

FIG. 6 shows an example of a timing chart for a variety of signals supplied to the CMOS image sensor upon flicker detection;

FIG. 7 is a chart for describing a fluctuation cycle of a luminance level of a 50 Hz fluorescent light;

FIG. 8 shows a circuit configuration of the CMOS image sensor having two output terminals for supplying a flicker detection video signal;

FIG. 9 shows an example of a timing chart of a variety of signals supplied to the CMOS image sensor having two output terminals for separately supplying flicker detection video signals sampled in different cycles;

FIG. 10 shows an example of a timing chart of a variety of signals supplied to the CMOS image sensor upon taking a still image;

FIG. 11 shows fluctuation of the luminance level when a light source illuminating an object is a repeatedly blinking light source, such as a fluorescent light;

FIG. 12 shows functional blocks of an image processing circuit according to the embodiment of the present invention;

FIG. 13 shows functional blocks of a white balance adjustment circuit according to the embodiment of the present invention;

FIG. 14 shows an example of light source regions of a fluorescent light and daylight defined on a color difference plane;

FIG. 15A shows an example of light source regions used by a white balance evaluation circuit to estimate the light source illuminating the object when flicker is present according to the embodiment of the present invention; and

FIG. 15B shows an example of light source regions used by the white balance evaluation circuit to estimate the light source illuminating the object when no flicker is present according to the embodiment of the present invention.

### DETAILED DESCRIPTION OF THE INVENTION

Preferred embodiments of the present invention (hereinafter referred to as “embodiments”) will be described with reference to the accompanying drawings.

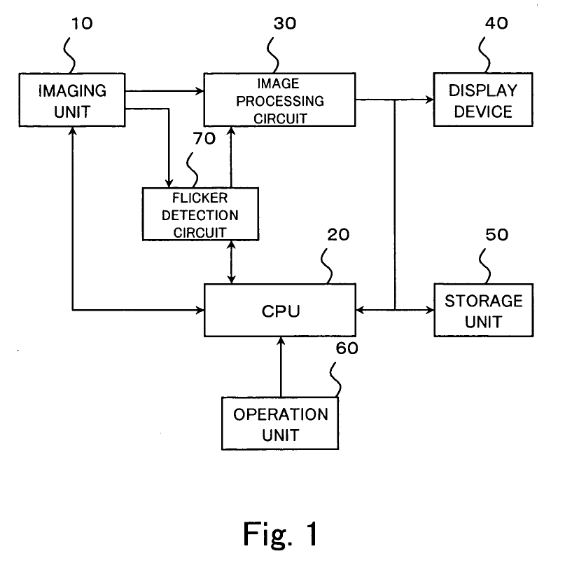

FIG. 1 is a functional block diagram of a digital camera according to the present embodiment. An imaging unit 10 receives light from an object under the control of a CPU 20, and supplies a video signal in accordance with the received light. The CPU 20 is a central processing unit controlling the entire digital camera for performing arithmetic operations for each circuit, controlling each circuit, and the like. An image processing circuit 30 performs predetermined image processing, such as white balance adjustment, on a video signal, and provides the resulting image data. A display device 40 sequentially displays a video image based on the image data to function as a viewfinder for photographing. A storage unit 50 records image data. An operation unit 60 is a user interface for a user to operate the digital camera when he/she takes a still image or a moving image using the digital camera. A flicker detection circuit 70 detects flicker of a light source, such as a fluorescent light, having a cyclically fluctuating luminance level.

According to the present embodiment, the image processing circuit 30 estimates the light source illuminating the object using a result of flicker detection by the flicker detection circuit 70, and adjusts the white balance in accordance with the detection result.

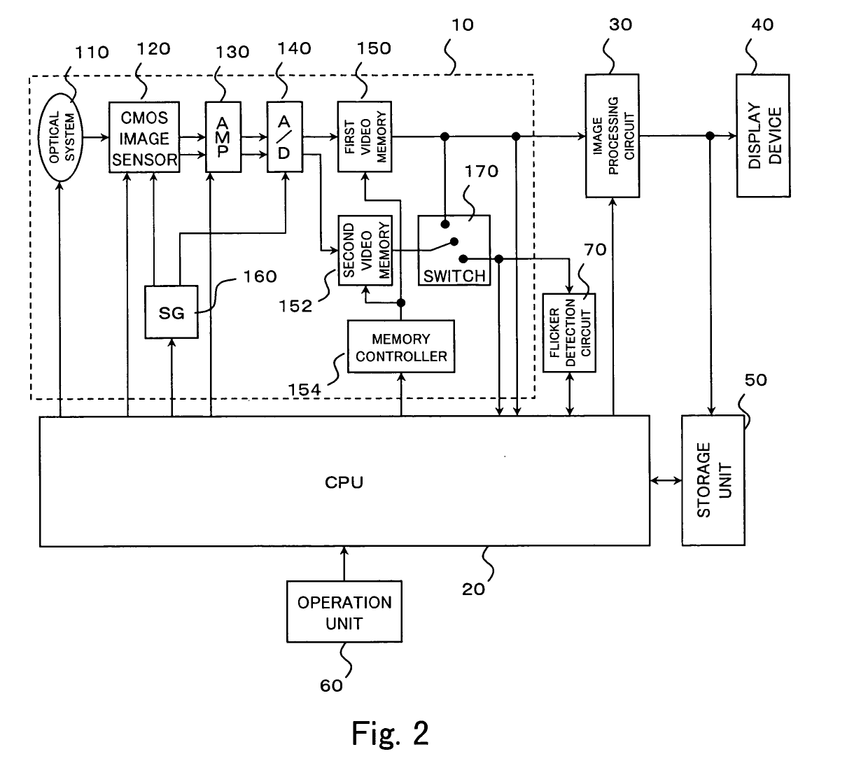

Next, the imaging unit 10 will be more specifically described. FIG. 2 more specifically shows functional blocks of the imaging unit 10 of the digital camera.

An optical system 110 includes a lens and an aperture diaphragm for allowing light from the object to enter a CMOS image sensor 120 so that a desired video signal is obtained. The CMOS image sensor 120 includes a plurality of pixel circuits and the like for performing photoelectric conversion on light received by each pixel circuit, and supplying a video signal. The CMOS image sensor 120 is an image sensor of an XY addressing type capable of controlling an output of the video signal for each pixel circuit regardless of pixel circuit arrangement. Further, according to the present embodiment, the CMOS image sensor 120 includes two output terminals for the video signal. When a video image is displayed on the display device 40, one of the output terminals supplies a display video signal used for displaying the video image on the display device 40, and the other supplies a flicker detection video signal used by the flicker detection circuit 70 to perform flicker detection. When a still image is taken, each output terminal supplies a recording video signal. A gain control amplifier (AMP) 130 adjusts a gain of each video signal. An analog/digital conversion circuit (A/D) 140 converts each video signal supplied from the AMP 130 to a digital signal. A signal generator (SG) 160 generates a signal for synchronization between the CPU 20 and the CMOS image sensor 120, between the CPU 20 and the AMP 130, and between the CPU 20 and the A/D 140.

A first video memory 150 temporarily holds the display or recording video signal supplied from the A/D 140. A second video memory 152 temporarily holds the flicker detection or recording video signal supplied from the A/D 140. A memory controller 154 controls output of each video signal held in the first and second video memories 150 and 152. A switch 170 switches whether to supply the flicker detection video signal held in the second video memory 152 to the flicker detection circuit 70 or to supply the recording video signal to the image processing circuit 30.

When a video image is displayed on the display device 40, the display video signal supplied from the first video memory 150 is input to the image processing circuit 30, and the flicker detection video signal supplied from the second video memory 152 is input to the flicker detection circuit 70. The image processing circuit 30 performs predetermined image processing on the display video signal, and supplies the resulting data to the display device 40. When a still image is taken, the image processing circuit 30 performs predetermined image processing on each recording video signal supplied from the first and second video memories 150 and 152, and produces image data for the still image.

The flicker detection circuit 70 detects flicker based on the flicker detection video signal, and supplies the detection result to the CPU 20. The CPU 20 supplies the detection result to the image processing circuit 30, which in turn estimates a light source illuminating an object using the detection result, and performs white balance adjustment of the input video signal.

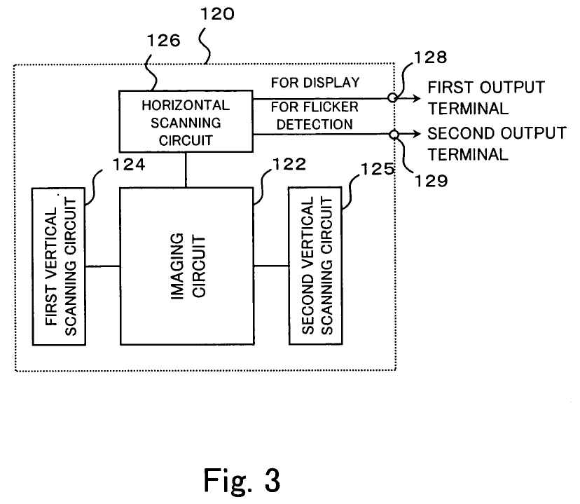

Operation of the CMOS image sensor 120 will next be described in further detail. FIG. 3 schematically shows a circuit configuration of the CMOS image sensor 120. An imaging circuit 122 includes a plurality of pixel circuits 200. The video signal is produced through photoelectric conversion of light received in each pixel circuit 200. A first vertical scanning circuit 124 transfers to a horizontal scanning circuit 126 the video signal supplied from each pixel circuit assigned for video image display on the display device 40 among a group of pixel circuits forming the imaging circuit 122. A second vertical scanning circuit 125 transfers to the horizontal scanning circuit 126 the video signal supplied from each pixel circuit assigned for flicker detection in the flicker detection circuit 70 among the group of pixel circuits forming the imaging circuit 122. The horizontal scanning circuit 126 supplies the video signal transferred from the first vertical scanning circuit 124 from a first output terminal 128, and supplies the video signal transferred from the second vertical scanning circuit 125 from a second output terminal 129.

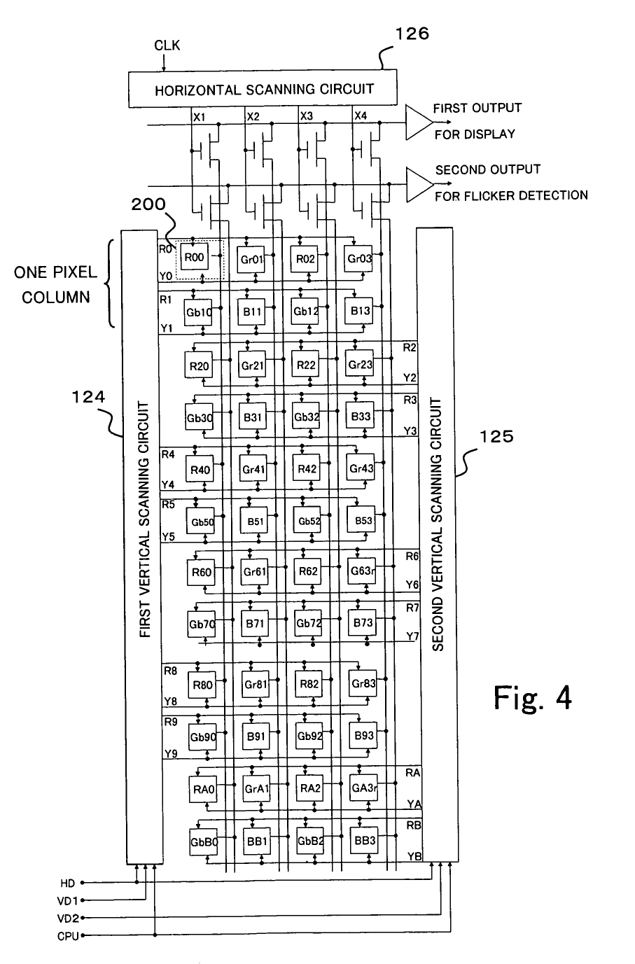

FIG. 4 shows in detail the circuit configuration of the CMOS image sensor 120. As illustrated in FIG. 4, the pixel circuits 200 forming the imaging circuit 122 are arranged in a lattice pattern, and a total of four imaging circuits 200, i.e. two circuits in a horizontal direction (from right to left in the figure) and two in a vertical direction (from top to bottom in the figure), form a pixel as a unit. Assuming that two rows of pixel circuits in the vertical direction form one pixel column, the pixel columns of the pixel circuits 200 are alternately connected to the first and second vertical scanning circuits 124 and 125. Each video signal supplied from each pixel circuit 200 connected to the first vertical scanning circuit 124 is output from the first output terminal 128 through the horizontal scanning circuit 126. On the other hand, each video signal supplied from each pixel circuit 200 connected to the second vertical scanning circuit 125 is output from the second output terminal 129 through the horizontal scanning circuit 126. Signals HD, VD1, VD2, and CPU in FIG. 4 are instruction signals output from the CPU 20. The signal HD is a horizontal synchronization signal for the horizontal scanning circuit 126, the signal VD1 is a vertical synchronization signal for the first vertical scanning circuit 124, and the signal VD2 is a vertical synchronization signal for the second vertical scanning circuit 125. The signal CPU is a reset signal or a selection signal for each pixel circuit. The reset and selection signals will be described later. Note that assignment of the group of pixel circuits connected to each vertical scanning circuit illustrated in FIG. 4 is illustrative only.

For example, the group of pixel circuits may be alternately connected to each vertical scanning circuit with the pixel column being composed of two columns of pixels as a unit.

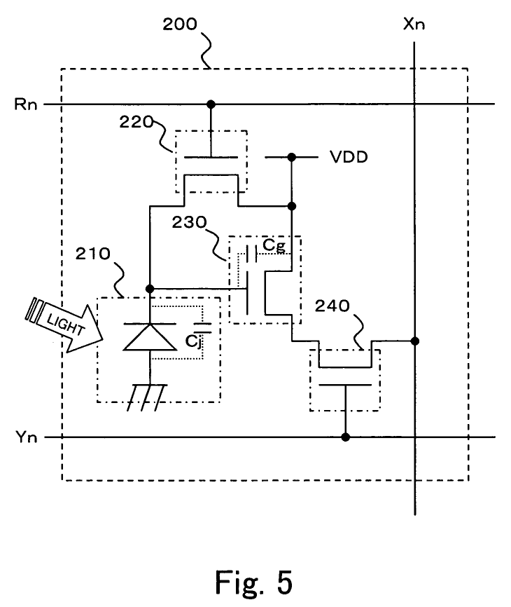

FIG. 5 shows in detail the circuit configuration of each pixel circuit 200 forming the imaging circuit 122. As illustrated in FIG. 5, a cathode side terminal of a photodiode 210 is connected to a voltage power source VDD through a reset switch 220, and to a gate terminal of an amplifying transistor 230. An output terminal of the amplifying transistor 230 is connected through a selection switch 240 to a signal output line Xn.

The pixel configured as described above operates in the following manner. The reset signal is applied to a gate electrode of the reset switch 220 through a reset signal line Rn to turn on the reset switch 220, thereby fixing a voltage of the photodiode 210 on the cathode side to a voltage VDD. Thereafter, when the reset switch 220 turns off, the photodiode 210 starts accumulation of photo charges. The potential of the photodiode 210 on the cathode side changes in accordance with such photo charge accumulation. The amount ΔV of change can be expressed by the following equation (1):
ΔV=Qph/(Cj+Cg) (1)
wherein Qph denotes the accumulated charges, Cj denotes the junction capacitance of the photodiode 210, and Cg denotes the gate capacitance of the amplifying transistor 230. After the charge accumulation period, the selection signal is applied to the gate electrode of the selection switch 240 through a selection signal line Yn to turn on the selection switch 240, and the video signal is supplied to the signal output line Xn. A current lout of the video signal flowing at this moment depends on the amount ΔV, and an amount of change ΔI approximately satisfies the following equation (2):
ΔIout=gm*×ΔV (2)
wherein gm* denotes a voltage-current conversion gain of an electric charge reading circuit including an ON resistance Ron of the selection switch 240 and the gain of the amplifying transistor 230, and is in the range of, for example, 1×10⁻³ (A/V) to 1×10⁴ (A/V).

As described above, between the time when the reset switch 220 is turned on/off by the reset signal and the time when the selection switch 240 is turned on by the selection signal, the photodiode 210 accumulates the photo charges, and the current lout corresponding to the amount of the charges is supplied. In other words, the pixel circuit 200 supplies the video signal in accordance with the amount of light received during an exposure period, which is between the turn-off of the reset switch 220 and the turn-on of the selection switch 240.

Operation of the CMOS image sensor 120 upon display and flicker detection will next be described.

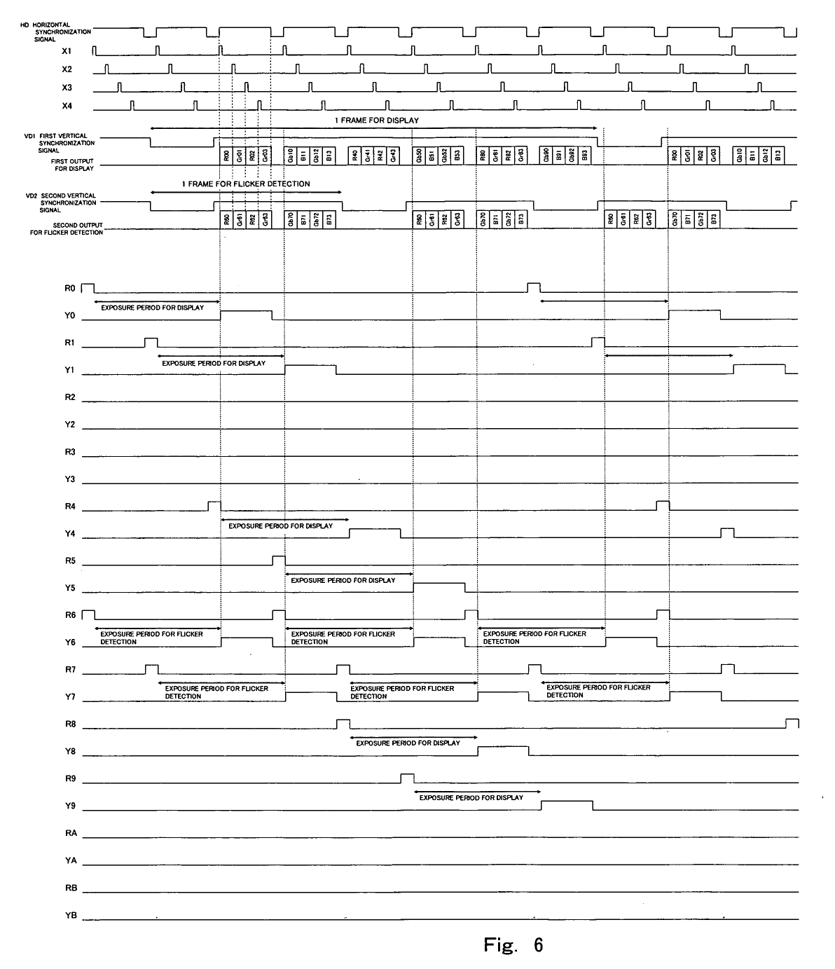

FIG. 6 shows an example of a timing chart for signals input to the CMOS image sensor 120. The pixel circuit 200 accepts a reset signal input from the connected vertical scanning circuit through the reset signal line Rn. Further, after a predetermined exposure period has elapsed, the selection signal is supplied to the pixel circuit 200 through the selection signal line Yn.

In accordance with the timing of each vertical synchronization signal (VD1, VD2), the video signal is supplied from each pixel circuit 200 through each vertical scanning circuit 124, 125, while in accordance with the timing of the horizontal synchronization signal (HD), the video signal is output from the corresponding output terminal 128, 129 through the horizontal scanning circuit 126.

The cycles of the first and second vertical synchronization signals correspond to each interval for reading out the video signal for one frame from the pixel circuit, i.e. a sampling frequency during sampling of the video signal for one frame output from the pixel circuit. The sampling frequency for the second vertical scanning circuit 125 (hereinafter referred to as a “second sampling frequency”) is preferably set taking into consideration a fluctuation cycle of a luminance level of a light source for which a flicker is to be detected because flicker detection is performed based on the video signal supplied through the second vertical scanning circuit 125.

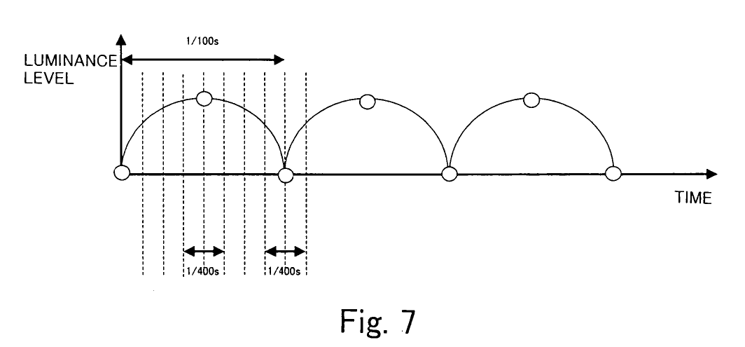

For example, the luminance level of a fluorescent light having a power source frequency of 50 Hz indicates repetitive blinking at the frequency of 100 Hz, as illustrated in FIG. 7. Accordingly, when the exposure period of the pixel circuit is set as 1/100s or an integral multiple thereof, the luminance level of the video signal read out at this timing is averaged, and flicker may not be detected. For accurate detection of a flicker in the 50 Hz fluorescent light, exposure must be conducted at the timing (indicated by circles in the figure) when the luminance marks the highest and lowest levels, and the video signals based on such exposure must be sequentially sampled. For example, in order to detect flicker in the 50 Hz fluorescent light, the video signal is sequentially sampled from each pixel circuit connected to the second vertical scanning circuit under conditions of an exposure period of 1/400s and a sampling frequency of 200 Hz, and flicker is detected based on such video signals. For flicker detection in a light source of a high-speed inverter type, such as a light source blinking repeatedly at 100 kHz, the exposure period and the sampling frequency are set at, for example, 1/4000000s and 200 kHz, respectively.

When the exposure period and the sampling frequency are set so as to detect flicker in a light source repeatedly blinking at a relatively high speed, such as a light source of a high-speed inverter type, flicker in a light source, such as a fluorescent light having a power source frequency of 50 Hz or 60 Hz, repeatedly blinking at a lower speed than the light source, such as a fluorescent light of the high-speed inverter type, can also be detected.

Although the amount of the received light may be too small to supply the appropriate video signal when the exposure period for each pixel circuit is shortened as described above, adjustment can be made to increase only the gain for the flicker detection video signal because the gain for the video signal can be individually adjusted in the CMOS image sensor 120 for each pixel circuit.

As described above, by setting the exposure period and the sampling frequency for each pixel circuit connected to the second vertical scanning circuit in accordance with the fluctuation cycle of the luminance level of the light source subjected to flicker detection, a flicker in that particular light source can be more accurately detected.

In the above description, the second sampling frequency, i.e. the cycle of the second vertical synchronization signal, is set based on the fluctuation cycle of the luminance level of the light source estimated as the light source illuminating the object, and the cycle has a single fixed value. However, when a plurality of light sources each having a different fluctuation cycle of the luminance level are estimated as the light source, the second vertical synchronization signals having different cycles for different fluctuation cycles may be prearranged, so that the cycles of the second vertical synchronization signals can be sequentially switched to sample the video signal. By thus performing flicker detection based on the video signal obtained through sampling in different cycles, flicker can be more accurately detected for a plurality of light sources with different fluctuation cycles of the luminance level.

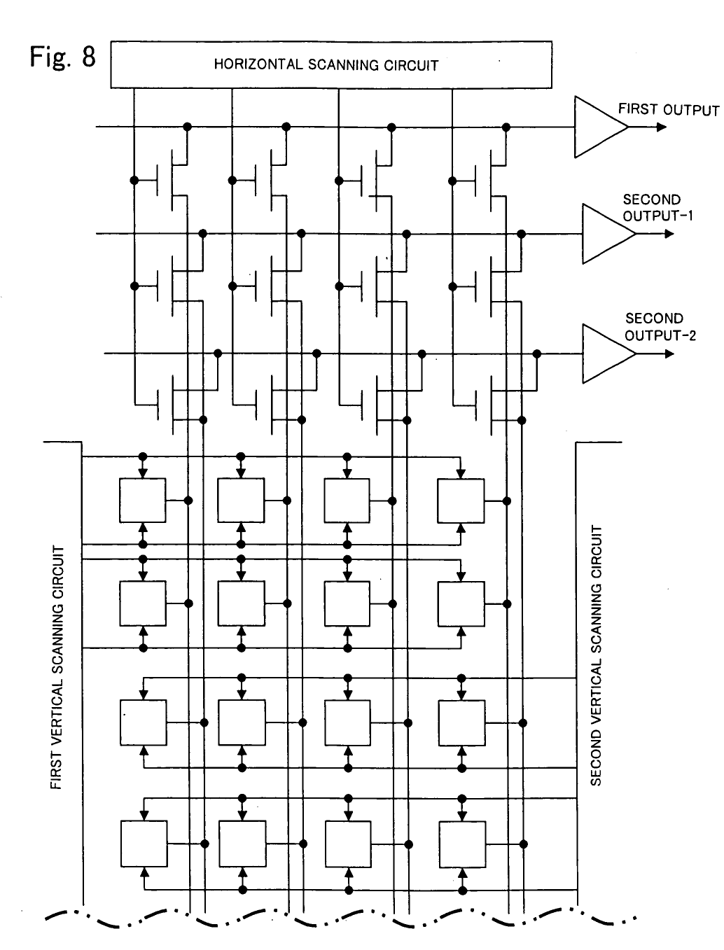

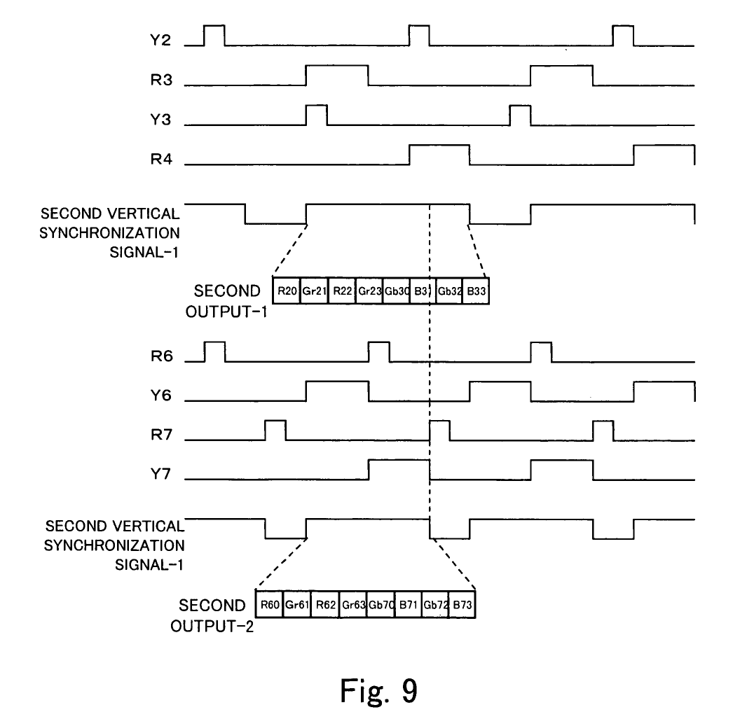

The video signal may be sampled through the second vertical synchronization signal having a different cycle for each pixel column. In such a case, the CMOS image sensor 120 is provided with as many output terminals supplying the flicker detection video signal as there are second vertical synchronization signals with different cycles. For example, when the video signal is supplied from different pixel columns based on two second vertical synchronization signals with different cycles, the CMOS image sensor 120 is provided with a circuit configuration shown in FIG. 8. More specifically, a second output-1 and a second output-2 are provided as the second output terminals for supplying the video signal from the group of pixel circuits connected to the second vertical scanning circuit. The video signal supplied from the group of pixel circuits based on the second vertical synchronization signal having one cycle is output from the second output-1, while the video signal based on the second vertical synchronization signal having the other cycle is output from the second output-2. Such a configuration makes it possible to supply the video signal from different pixel columns based on two second vertical synchronization signals having different cycles. FIG. 9 shows an example of a timing chart for the signals (the reset signal, the selection signal, and the vertical synchronization signal) in which the video signals are supplied from different pixel columns based on the two second vertical synchronization signals with different cycles.

Operation of the CMOS image sensor 120 when a still image is captured will next be described.

FIG. 10 is a timing chart of signals supplied to each pixel circuit 200 when a still image is captured. The operation differs from that upon display and flicker detection in that each pixel circuit 200 connected to the first and second vertical scanning circuits are operated by a vertical synchronization signal having the same cycle and the same recording exposure period.

By such operation of the CMOS image sensor 120, the recording video signals are output from the first and second output terminals 128 and 129, and each video signal is temporarily held in the first video memory 150 or the second video memory 152 through the AMP 130 and the A/D 140. The recording video signals temporarily held in the first and second video image memories 150 and 152 are sequentially supplied to the image processing circuit 30. The image processing circuit 30 performs predetermined image processing on a group of recording video signals for one frame, and records the processed data in the storage unit 50 as image data.

A method of detecting flicker by the flicker detection circuit 70 will next be described. Flicker detection by the flicker detection circuit can be performed by a general method, as in the following example.

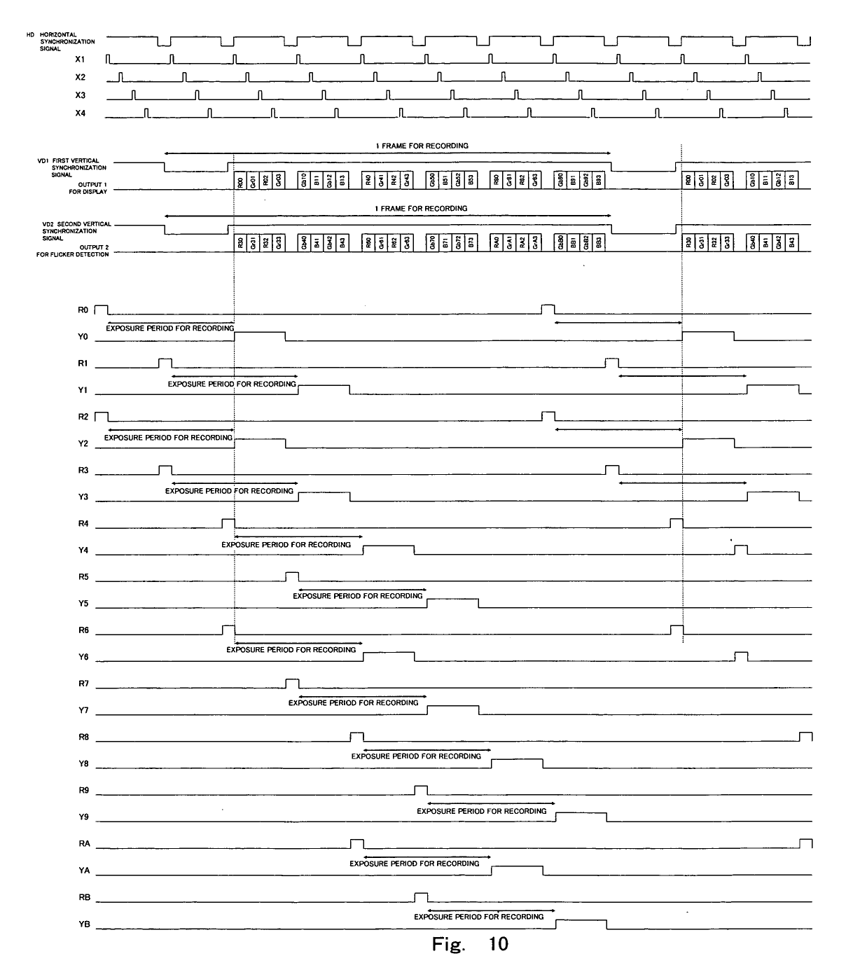

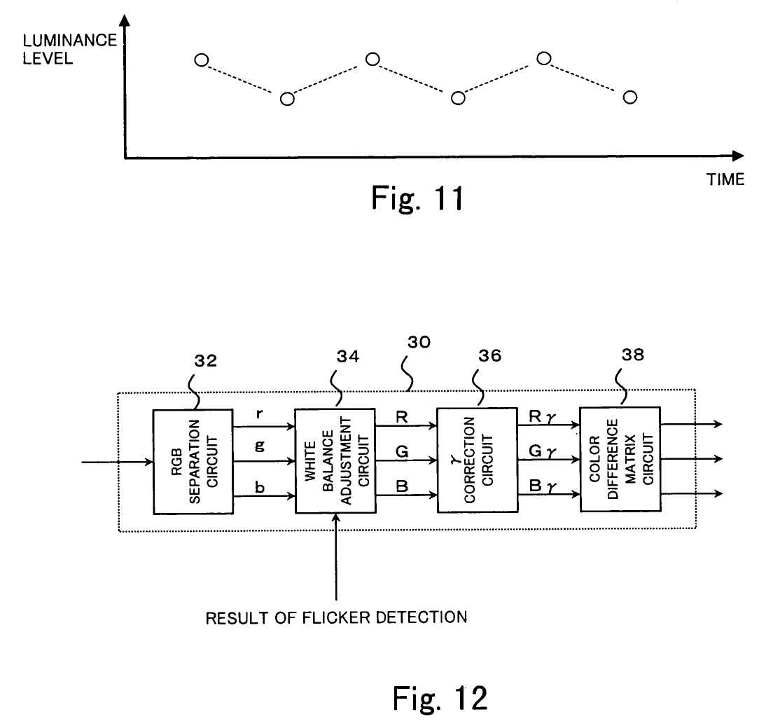

The flicker detection circuit 70 accepts input of the flicker detection video signal temporarily held in the second video memory 152 through the switch 170. When the light source illuminating the object is a repeatedly blinking light source, such as a fluorescent light, the luminance level of the flicker detection video signal fluctuates cyclically, as illustrated in FIG. 11. Therefore, the flicker detection circuit 70 can detect the presence or absence of a flicker based on whether or not the luminance level fluctuates cyclically. Whether the luminance level fluctuates cyclically or not can be determined based on, for example, the degree of variation in luminance level of each video signal by referring to history of the luminance level of each input video signal stored for a predetermined period in the flicker detection circuit 70.

The flicker detection circuit 70 can sequentially compare the luminance level of the previously input video signal and that of the newly input video signal, and count the number of the video signals whose luminance levels differ by a predetermined value, and flicker detection is determined when the count exceeds a predetermined value.

As described above, the flicker detection circuit 70 determines whether or not the light source for the object causes flicker based on the flicker detection video signal temporarily held in the second video memory 152, and supplies the determination result to the CPU 20. The CPU 20 provides the determination result to the image processing circuit 30, which estimates the light source for the object based on the determination result, i.e. the presence or absence of flicker, and performs white balance adjustment in accordance with the estimation result.

According to the present embodiment, flicker can be accurately detected based on the flicker detection video signal supplied by the group of pixel circuits while the video image based on the display video signal supplied by the group of pixel circuits is presented on the display device 40 without providing a dedicated flicker detection device, such as an external sensor for detecting flicker, in a digital camera.

The image processing circuit 30 will next be described in detail. FIG. 12 shows detailed functional blocks of the image processing circuit 30.

An RGB separation circuit 32 separates an input video signal into RGB components to be supplied as color signals. A white balance adjustment circuit 34 estimates a light source of an object based on luminance and color difference of the RGB color signals, and adjusts white balance on the RGB color signals based on the estimation result. The present embodiment is characterized in that the white balance adjustment circuit 34 estimates the light source of the object taking into consideration the flicker detection result provided by the flicker detection circuit 70. A γ correction circuit 36 performs γ correction on the RGB color signals having adjusted white balance, thereby performing tone correction. A color difference matrix circuit 38 performs color difference matrix conversion on the γ-corrected RGB color signals, and supplies a luminance signal (Y) and color difference signals (R-Y, B-Y).

The video signal input to the image processing circuit 30 is subjected to the above-described image processing, thereby causing the processing result to be displayed on the display device 40 as a video image, or to be recorded in the storage unit 50 as image data.

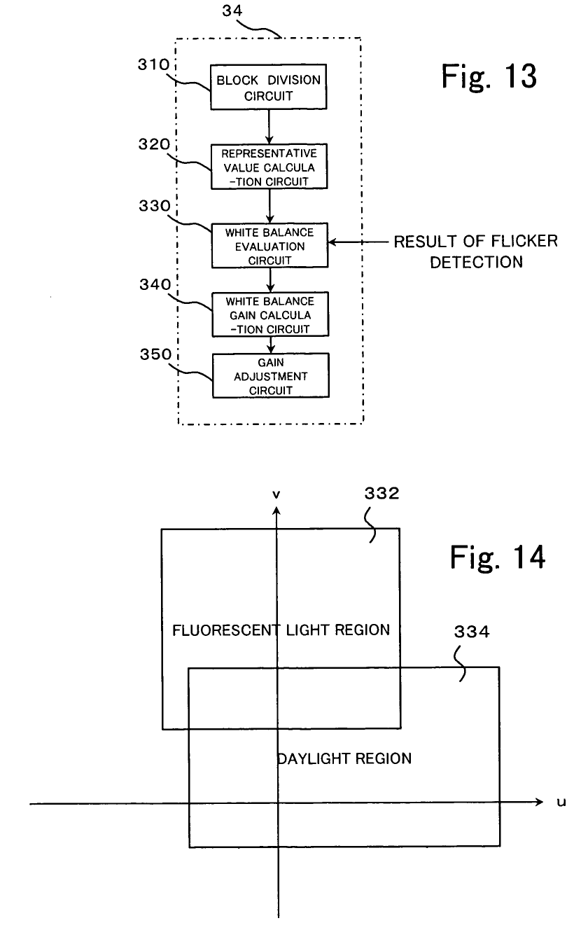

The white balance adjustment circuit 34 will be further described. FIG. 13 shows functional blocks of the white balance adjustment circuit 34. The white balance adjustment circuit described hereinafter is illustrative only, and alternative circuits may also be used as long as they adjust white balance based on the result of estimating the light source illuminating the object. For description purposes, the RGB color signals for one frame will be defined as a single image signal.

A block division circuit 310 obtains a single image signal from the RGB color signals for one frame input from the RGB separation circuit 32, and divides the image signal into a plurality of blocks. Further, a representative value calculation circuit 320 calculates for each block an average of the color signals (R, G, B) in the block, and performs linear transformation on the calculated average based on the following expression (3), thereby obtaining luminance (L) and color difference (u, v) as values representing the block (hereinafter referred to as representative values).

$$( \begin{matrix}L \\ u \\ v\end{matrix} ) = ( \begin{matrix}1 / 4 & 1 / 2 & 1 / 4 \\ - 1 / 4 & 1 / 2 & - 1 / 4 \\ - 1 / 2 & 0 & 1 / 2\end{matrix} ) ( \begin{matrix}R \\ G \\ B\end{matrix} ) \qquad ( 3 )$$

A white balance evaluation circuit 330 estimates the light source illuminating the object based on the calculated representative value and the like for each block. A white balance gain calculation circuit 340 calculates a gain for white balance adjustment based on the estimation result, and a gain adjustment circuit 350 adjusts white balance of the input RGB color signals based on the gain.

The gain for white balance adjustment is obtained as a value correcting estimated color of light of the light source illuminating the object to gray (achromatic color). Assuming that the estimated color of illumination is denoted as (IL, Iu, Iv), the gain (Rgain, Ggain, Bgain) for white balance adjustment can be derived from the following expressions (4)-(6).

$$( \begin{matrix}IR \\ IG \\ IB\end{matrix} ) = ( \begin{matrix}1 & - 1 & - 1 \\ 1 & 1 & 0 \\ 1 & - 1 & 1\end{matrix} ) ( \begin{matrix}IL \\ Iu \\ Iv\end{matrix} ) \qquad ( 4 )$$

Imax=max(IR,IG,IB) (5)
Rgain=Imax/IR,Ggain=Imax/IG,Bgain=Imax/IB (6)
wherein (IR, IG, IB) is RGB expression of the color of the illumination.

The derived white balance gain (Rgain, Ggain, Bgain) is a value correcting the color appearing when the illumination of this color (i.e. (IR, IG, IB) itself) is reflected by a white object to gray (i.e. R=G=B). The derived white balance gain is input to the gain adjustment circuit 350.

The gain adjustment circuit 350 multiplies the RGB color signals by the gain (Rgain, Ggain, Bgain) calculated by the white balance gain calculation circuit 340, thereby adjusting white balance of the image signal. Therefore, an output (Rout, Gout, Bout) derived by the following equation (7) is supplied from the white balance adjustment circuit 34:
Rout=Rgain*R,Gout=Ggain*G,Bout=Bgain*B (7)

A method of estimating a light source illuminating an object in the white balance evaluation circuit 330 will next be described. For simplicity of description, the light source illuminating the object is assumed as a fluorescent light and daylight.

The white balance evaluation circuit 330 checks whether a color difference component of a representative value for each block is included in a fluorescent light region 332 or a daylight region 334 predefined on a color difference plane shown in FIG. 14, thereby estimating the light source for each block. Note that the fluorescent light region 332 is a range of values that can be taken by a color difference component of a white object under fluorescent lighting, and that the daylight region 334 is a range of values that can be taken by a color difference component of a white object under daylight, i.e. solar light. Each region is predefined by experiments and the like.

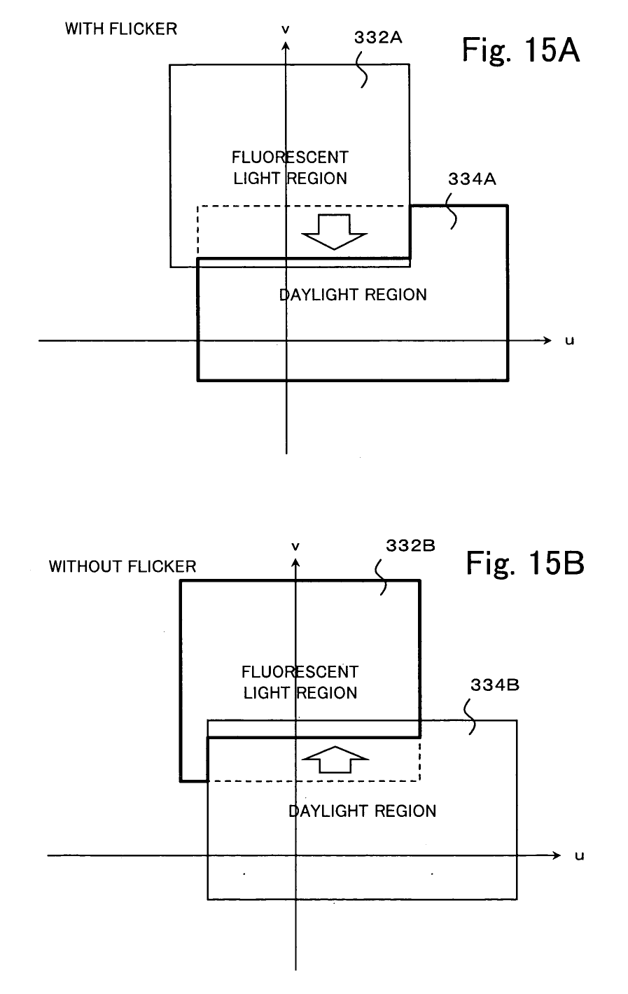

As illustrated in FIG. 14, the color difference component of the white object under fluorescent lighting and that under daylight are close to each other. As a result, the light source estimation using color difference components have often been incorrect, thereby preventing appropriate white balance adjustment. According to the present embodiment, the fluorescent light region 332 and the daylight region 334 defined on the color difference plane are modified in accordance with the flicker detection result. More specifically, the white balance evaluation circuit 330 estimates the light source based on the fluorescent light region and the daylight region each defined separately for the cases with and without flicker. FIG. 15A shows light source regions used when flicker is present, and defined so that a smaller portion of the daylight region overlaps the fluorescent light region. On the other hand, FIG. 15B shows light source regions used when no flicker is present, and defined so that a smaller portion of the fluorescent light region overlaps the daylight region.

Thus, the light source regions on the color difference plane used for light source estimation are changed in accordance with presence or absence of flicker, achieving more appropriate light source estimation. More specifically, when flicker is determined as being present by the flicker detection circuit 70, the light source is more likely to be a fluorescent light than daylight. Therefore, the area where the daylight region and the fluorescent light region overlap is shifted toward the fluorescent light region, thereby making it easier for the white balance evaluation circuit 330 to determine the light source of the object as the fluorescent light. On the other hand, when it is determined that no flicker is present by the flicker detection circuit 70, the light source is more likely to be daylight light than a fluorescent light. Therefore, the area where the daylight region and the fluorescent light region overlap is shifted toward the daylight region, thereby making it easier for the white balance evaluation circuit 330 to determine the light source of the object as daylight. Consequently, the white balance evaluation circuit 330 can estimate the light source more appropriately, thereby reducing inappropriate white balance adjustment.

In the above description, the white balance evaluation circuit 330 changes the light source regions based on the result of flicker detection performed based on the video signal. However, if a user makes a selection prior to photographing as to whether a picture is taken indoors or outdoors and the white balance evaluation circuit 330 judges based on the selection result that flicker is present when a picture is taken indoors or that no flicker is present when it is taken outdoors, the white balance evaluation circuit 330 can simply determine the presence or absence of flicker without providing a circuit, such as the flicker detection circuit 70. While a CMOS image sensor is described above as an example of the image sensor, any other image sensor can be used as long as the sensor can form an image of an object on an imaging plane and extract an electrical signal corresponding to intensity of the light as a video signal.

What is claimed is:

1. A digital camera for performing white balance adjustment on a video signal corresponding to an object and output from an image sensor, comprising:
a light source estimation circuit for estimating a light source illuminating the object by checking, among a plurality of light source regions predefined on a color difference plane, which region includes a color difference component of the video signal;
an adjustment circuit for adjusting white balance of the video signal in accordance with the estimated light source; and
a flicker detection circuit for detecting flicker of the light source illuminating the object; wherein
the light source estimation circuit changes the light source region based on a result of flicker detection performed by the flicker detection circuit.

2. A digital camera according to claim 1, wherein
at least a fluorescent light region and a daylight region are defined as the light source regions, and
the light source estimation circuit reduces an area of the daylight region overlapping the fluorescent light region when the result of flicker detection indicates that a flicker is present.

3. A digital camera according to claim 1, wherein
at least a fluorescent light region and a daylight region are defined as the light source regions, and
the light source estimation circuit reduces an area of the fluorescent light region overlapping the daylight light region when the result of flicker detection indicates that no flicker is present.

4. A white balance adjustment method for adjusting white balance of a video signal corresponding to an object and output from an image sensor, comprising:
a flicker detection step for detecting flicker of a light source illuminating the object;
a region changing step for changing at least part of a plurality of light source regions predefined on a color difference plane based on a result of flicker detection;
a light source estimation step for estimating the light source of the object by checking which of the plurality of light source regions predefined on the color difference plane and containing the changed region includes a color difference component of the video signal; and
an adjustment step for adjusting white balance of the video signal in accordance with the estimated light source.

5. A white balance adjustment method according to claim 4, wherein
at least a fluorescent light region and a daylight region are defined as the light source regions, and
at the light source estimation step, an area of the daylight region overlapping the fluorescent light region is reduced when the result of flicker detection indicates that flicker is present.

6. A white balance adjustment method according to claim 4, wherein
at least a fluorescent light region and a daylight region are defined as the light source regions, and
at the light source estimation step, an area of the fluorescent light region overlapping the daylight light region is reduced when the result of flicker detection indicates that no flicker is present.
